(19) United States
(12) Patent Application Publication
(10) Pub. No.: US 2025/0069541 A1
(43) Pub. Date: Feb. 27, 2025

(54) DATA-TO-SCAN COUPLING INDUCED ERROR COMPENSATION

(71) Applicant: Apple Inc., Cupertino, CA (US)

(72) Inventors: Jongyup Lim, San Jose, CA (US); Jie Won Ryu, San Jose, CA (US); Nicolas Le Dortz, Cupertino, CA (US); Hyunwoo Nho, Palo Alto, CA (US); Sun-Il Chang, San Jose, CA (US); Patrick R. Cruce, Campbell, CA (US)

(73) Assignee: Apple Inc., Cupertino, CA (US)

(21) Appl. No.: 18/780,367

(22) Filed: Jul. 22, 2024

Related U.S. Application Data
(60) Provisional application No. 63/534,313, filed on Aug. 23, 2023.

(51) Int. Cl. G09G 3/20; G09G 3/32; G09G 3/3208; G09G 3/36

(52) U.S. Cl. CPC G09G 3/2096; G09G 3/32; G09G 3/3208; G09G 3/36; G09G 2320/0233; G09G 2320/0242

(57) ABSTRACT

An electronic display device designed to a method and device that corrects for distorted luminance and colors due to data-to-scan coupling in a flat-panel display.

### CROSS-REFERENCES TO OTHER APPLICATIONS

This application claims priority to U.S. Provisional Application No. 63/534,313, for “DATA-TO-SCAN COUPLING INDUCED ERROR COMPENSATION” filed on Aug. 23, 2023, which is herein incorporated by reference in its entirety for all purposes.

### BACKGROUND

Aspects of the disclosure relate in general to flat-panel displays. Aspects include a method and device that corrects for distorted luminance and colors due to data-to-scan coupling in the flat-panel display.

### DESCRIPTION OF THE RELATED ART

Displays are electronic viewing technologies used to enable people to see content, such as still images, moving images, text, or other visual material.

A flat-panel display includes a display panel including a plurality of pixels arranged in a matrix format. The display panel includes a plurality of scan lines formed in a row direction (y-axis) and a plurality of data lines formed in a column direction (x-axis). The plurality of scan lines and the plurality of data lines are arranged to cross each other. Each pixel is driven by a scan signal and a data signal supplied from its corresponding scan line and data line.

Flat-panel displays can be classified as passive matrix type light emitting display devices or active matrix type light emitting display devices. Active matrix panels selectively light every unit pixel. Active matrix panels are used due to their resolution, contrast, and operation speed characteristics.

One type of active matrix display is an active matrix organic light emitting diode (AMOLED) display. The active matrix organic light emitting display produces an image by causing a current to flow to an organic light emitting diode to produce light. The organic light emitting diode is a light-emitting element in a pixel. The driving thin film transistor (TFT) of each pixel causes a current to flow in accordance with the gradation of image data.

Brightness of AMOLED display is directly proportional to the amount of current consumed. In other words, a larger emission current results in higher display brightness value (DBV). The emission current is controlled by pixel data voltage.

Flat-panel displays are used in many portable devices such as laptops, mobile phones, smartphones, tablet computers, and other digital devices.

### SUMMARY

Embodiments include an electronic display designed to correct for distorted luminance and color due to data-to-scan signal coupling in a flat-panel display.

One embodiment is a method of operating an electronic display apparatus. The apparatus receives an input signal frame comprising lines of pixels. A line subtractor calculates data voltage transition between the lines of pixels resulting in a spatial interpolated voltage transition calculation. A group average averages a voltage across each column within the lines of pixels resulting in a group average voltage. For each scan phase an aggressor value is calculated using using the spatial interpolated voltage transition calculation and the group average voltage. For each scan phase, the aggressor value and an input sub-pixel value are used to correct compensation correction voltage values using by aligning with a corresponding first-in first-out (FIFO) buffer. The compensation correction voltage values are summed with the input signal frame to result in a compensated output image frame. A display panel displays the compensated output image frame.

Another embodiment is an electronic apparatus comprising a display panel and a display driver. The apparatus receives an input signal frame comprising lines of pixels. A line subtractor calculates data voltage transition between the lines of pixels resulting in a spatial interpolated voltage transition calculation. A group average averages a voltage across each column within the lines of pixels resulting in a group average voltage. For each scan phase an aggressor value is calculated using using the spatial interpolated voltage transition calculation and the group average voltage. For each scan phase, the aggressor value and an input sub-pixel value are used to correct compensation correction voltage values using by aligning with a corresponding first-in first-out (FIFO) buffer. The compensation correction voltage values are summed with the input signal frame to result in a compensated output image frame. A display panel displays the compensated output image frame.

Another embodiment is a non-transitory computer readable medium encoded with data and instructions. When executed by the electronic apparatus, the instructions causing the electronic apparatus to correct for distorted luminance and color due to data-to-scan signal coupling in a flat-panel display. The apparatus receives an input signal frame comprising lines of pixels. A line subtractor calculates data voltage transition between the lines of pixels resulting in a spatial interpolated voltage transition calculation. A group average averages a voltage across each column within the lines of pixels resulting in a group average voltage. For each scan phase an aggressor value is calculated using using the spatial interpolated voltage transition calculation and the group average voltage. For each scan phase, the aggressor value and an input sub-pixel value are used to correct compensation correction voltage values using by aligning with a corresponding first-in first-out (FIFO) buffer. The compensation correction voltage values are summed with the input signal frame to result in a compensated output image frame. A display panel displays the compensated output image frame.

To better understand the nature and advantages of the present disclosure, reference should be made to the following description and the accompanying figures. It is to be understood, however, that each of the figures is provided for the purpose of illustration only and is not intended as a definition of the limits of the scope of the present disclosure. Also, as a general rule, and unless it is evident to the contrary from the description, where elements in different figures use identical reference numbers, the elements are generally either identical or at least similar in function or purpose.

### BRIEF DESCRIPTION OF THE DRAWINGS

FIG. 1A illustrates a sample input signal for a flat-panel display.

FIG. 1B depicts a sample output image for a flat-panel display; the output image contains distorted luminance and color due to data-to-scan signal coupling.

FIG. 2 is illustrates a differential due to data voltage swing of adjacent sub-pixels.

FIG. 3 is a simplified pixel diagram explaining the cause of the distorted luminance and color.

FIG. 4 is a block diagram of a flat-panel display configured to corrected for distorted luminance and color due to data-to-scan signal coupling.

FIG. 5 is a block diagram of an embodiment of a display driver integrated circuit designed to correct for distorted luminance and color due to data-to-scan signal coupling.

### DETAILED DESCRIPTION

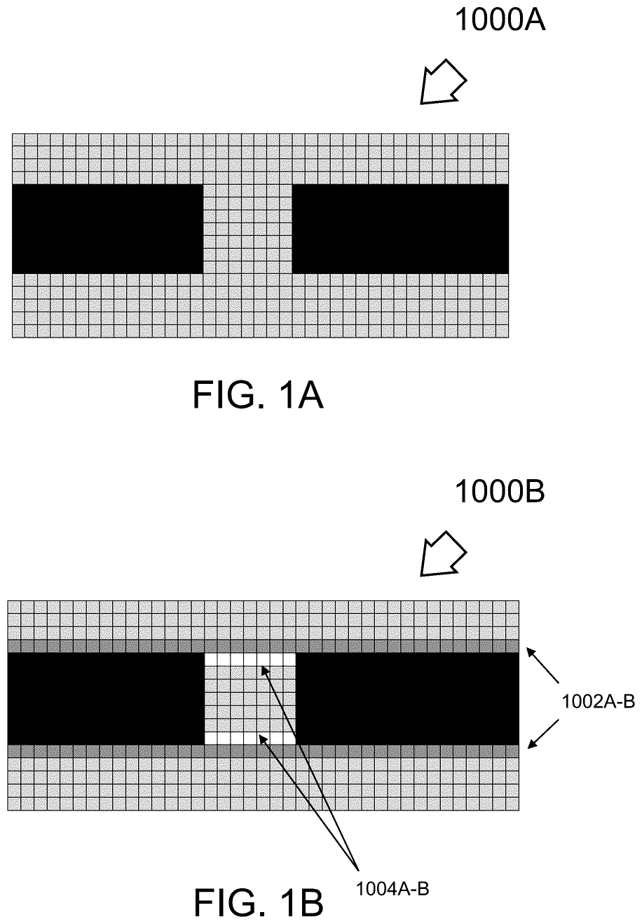

An aspect of the disclosure includes the observation that conventional flat-panel displays may experience distorted luminance and color effects due to data-to-scan signal coupling. An input signal may contain multiple frames for viewing on a flat-panel display. Specifically, FIG. 1A illustrates a sample input signal frame 1000A intended for viewing on a conventional flat-panel display. Typically, the sample input signal frame 1000A comprises multiple lines of pixel data which encode the color and intensity information of each pixel. The sample input signal 1000A is received by the conventional flat-panel display which outputs a sample output image 1000B, as shown in FIG. 1B. When compared against the sample input signal 1000A, the sample output image 1000B contains both darker lines 1002A-B and brighter lines 1004A-B than the original sample input signal 1000A.

Another aspect of the disclosure includes the investigation and realization of the causes of the output image distortion. The distorted luminance and color of the darker lines 1002A-B and brighter lines 1004A-B are due to two causes.

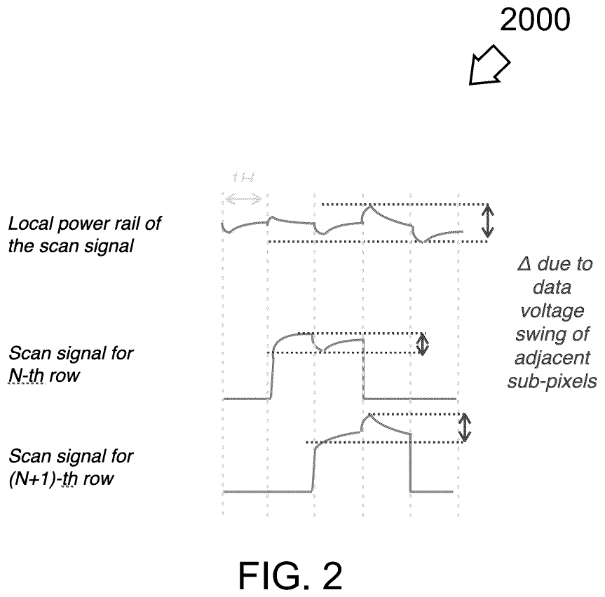

The first cause is a coupling of data toggling-to-scan power rail between the adjacent image pixel lines. As shown in FIG. 2, data voltage swings of neighboring sub-pixels are coupled through the local power-rail of the scan signals. The coupling contributes to sampled error of the sub-pixel. Different scan signals are affected by data voltage swings during different scan phases. The sampled error magnitude is relative to the data voltage swing.

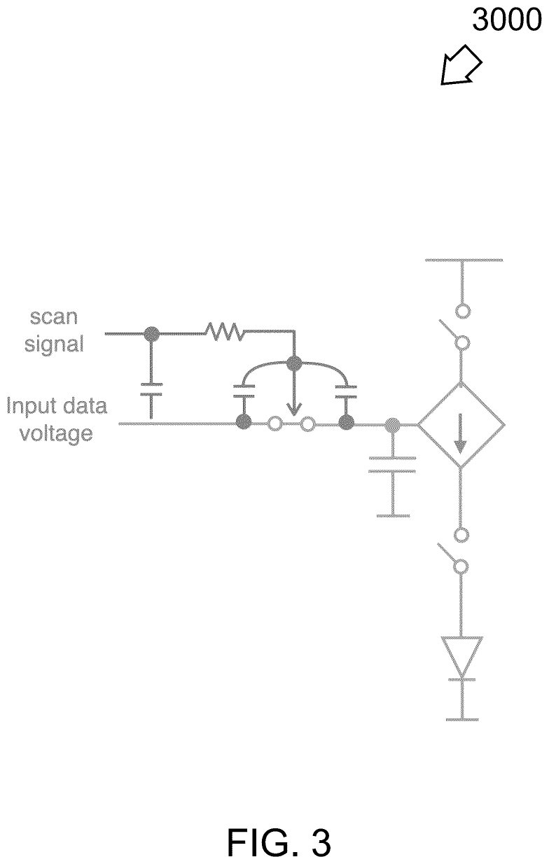

The second cause is capacitive loading dependence between two adjacent image pixel rows. As shown in a simplified pixel diagram of FIG. 3, capacitive loading results from the local power-rail of the scan signals. The capacitive loading may be determined by a row average of image sub-pixels of the one or two adjacent rows where the image pixel is located.

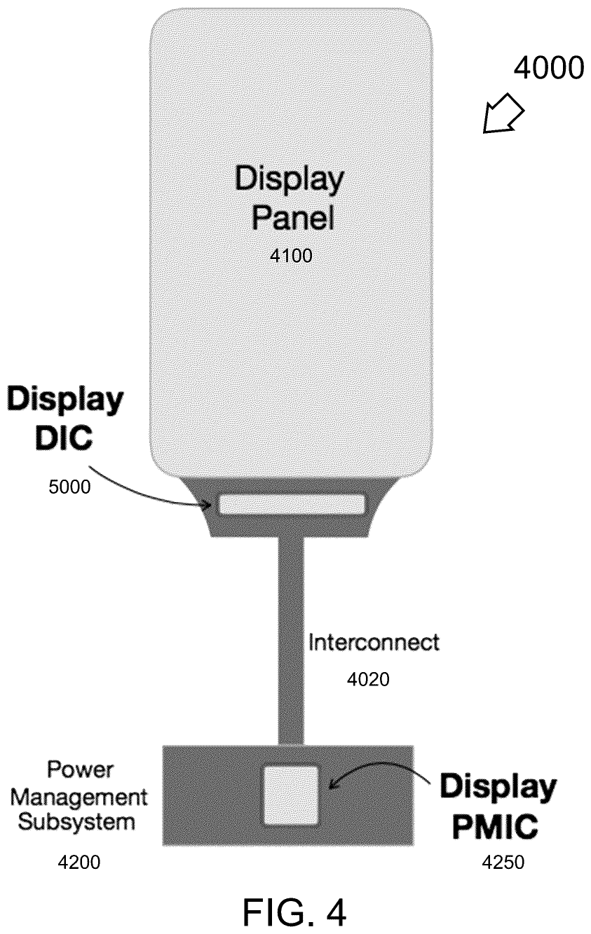

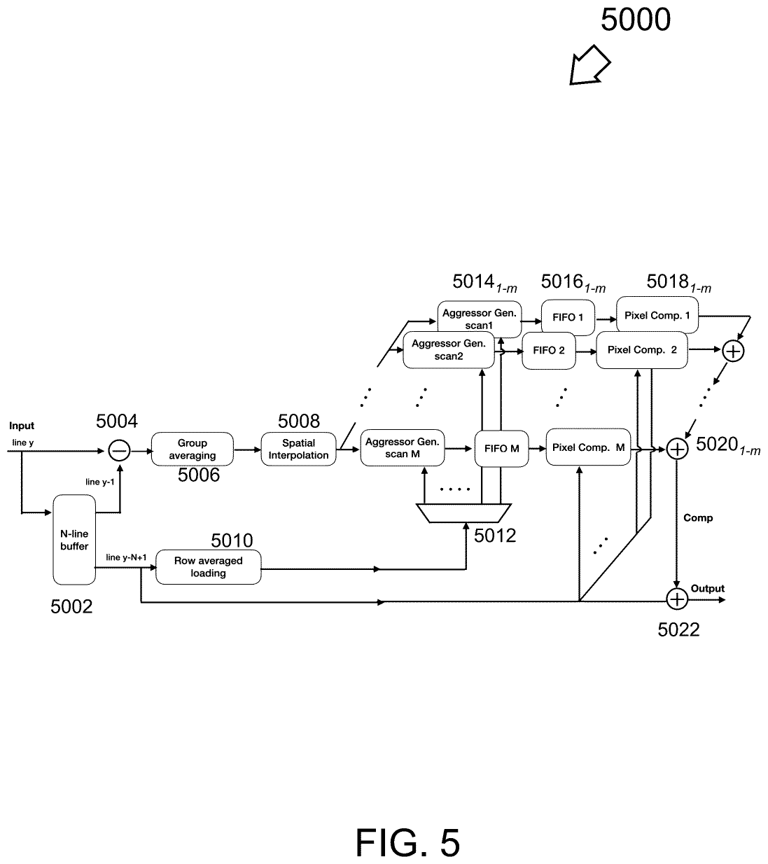

In order to better appreciate the features and aspects of the present disclosure, further context for the disclosure is provided in the following section by discussing an implementation of a flat-panel display that addresses correct for distorted luminance and color due to data-to-scan signal coupling in a flat-panel display, as described FIG. 4 and FIG. 5. FIG. 4 depicts an implementation of a display device 4000, while FIG. 5 illustrates an embodiment of a display driver integrated circuit (DDIC) 5000 configured to correct for distorted luminance and color due to data-to-scan signal coupling in the display device 4000, constructed and operative in accordance with a present embodiment of the disclosure.

These embodiments are for explanatory purposes only and other embodiments may be employed in other display devices. For example, embodiments of the disclosure can be used with any display device that compensates for distorted luminance and color due to data-to-scan signal coupling. It is further understood that display device 4000 may be a computer, tablet computer, mobile phone, digital watch, augmented reality headset or any other visual display device.

FIG. 4 is a block diagram of a display device 4000 configured to correct for distorted luminance and colors due to data-to-scan coupling in a flat-panel display. Display device 4000 comprises a display panel 4100, a power management subsystem 4200, and a display driver integrated circuit (DDIC) 5000. These components are connected via interconnect 4020, as is known in the art.

The display panel 4100 may be an organic light-emitting diode (OLED) display, such as a passive-matrix (PMOLED) or active-matrix (AMOLED). In other embodiments, the display panel 4100 may be a liquid crystal display (LCD) or micro-light emitting diode (micro-LED) display. The display panel 4100 displays an image based upon the pixel display voltage and is powered by an electroluminescence voltage. The pixel display voltage is received from the display driver integrated circuit 5000, and the power management integrated circuit 4100 supplies the electroluminescence voltage.

The power management subsystem 4200 is configured to supply an electroluminescence voltage to the display panel 4100, and may perform electronic power conversion (such as dynamic voltage scaling) and/or power control functions. The power management subsystem 4200 may be implemented as a power management integrated circuit (PMIC) 4250 configured to correct for distorted luminance and color due to data-to-scan signal coupling in the display device 4000.

In some embodiments when display panel 4100 is current driven, such as an OLED display, the power management integrated circuit 4250 may drive the current through a gate of a Metal Oxide Semiconductor (MOS) transistor. In such an embodiment, each pixel of the display panel 4100 may be equipped with a MOS transistor (field effect transistor) with a switching function.

FIG. 5 is a block diagram of an embodiment of a display driver integrated circuit 5000. The display driver integrated circuit (DDIC) 5000 is a semiconductor integrated circuit that provides an interface function between the display panel 4100 and a microprocessor, microcontroller, application specific integrated circuit or other general-purpose peripheral interface (not shown). It is understood by one or ordinary skill in the art that FIG. 5 is but one implementation of display driver integrated circuit 5000, and other embodiments may exist.

As shown in FIG. 5, the display driver integrated circuit 5000 corrects for distorted luminance and color due to data-to-scan signal coupling by addressing both the coupling of data toggling-to-scan power rail between the adjacent image pixel lines and the capacitive loading dependence between two adjacent image pixel rows. Consequently, an embodiment display driver integrated circuit 5000 may perform aggressor generation and compensation for each scan phase.

In an illustrative embodiment display driver integrated circuit 5000 comprises an N-line buffer 5002, line subtractor 5004, group averager 5006, spatial interpolator 5008, row averager 5010, demultiplexer 5012, aggressor generator 5014₁₋ₘ, first-in first out (FIFO) buffer 5016₁₋ₘ, pixel compensator 5018₁₋ₘ, line adders 5020₁₋ₘ, and output adder 5022. These components may be better understood in operation.

Initially, display driver integrated circuit 5000 receives an input signal, such as sample input signal 1000A. The input signal is separated into constituent lines and provided to N-line buffer 5002. A data voltage transition between lines is calculated and group averaged across a column with a spatial scaling factor. Each line_{y} is compared with a previous line_{y-1} by line subtractor 5004. The data voltage transitions are provided to a group averager 5006 and a spatial interpolator 5008, and is used by aggressor generator 5014₁₋ₘ for each scan phase and buffered through a first-in first out (FIFO) buffer 5016₁₋ₘ. Depending upon implementation, there may be different scan phases, such as such as an initializing phase, threshold sampling phase, post-threshold sampling phase, pixel programming phase or other phases known in the art.

For a programming scan phase, which is dependent to capacitive loading, the average of the loading over the current line (one or two lines) is calculated by row averager 5010 and used as an input parameter for proper aggressor generation via demultiplexer 5012.

A correct compensation value per each scan phase is calculated using the calculated aggressor from aggressor generator 5014₁₋ₘ and input victim sub-pixel value by pixel compensator 5018₁₋ₘ. Compensation value per each scan phase is properly aligned by corresponding first-in first-out (FIFO) buffer 5016₁₋ₘ, and summed up with the input data to generate final output frame by line adders 5020₁₋ₘ and output adder 5022. The resulting output frame results in display panel uniformity with no perceivable luminance and color error artifacts such as 1002A-B or 1004A-B. The output frame is then provided to display panel 4100 for display.

In some embodiments, the display driver integrated circuit 5000 may alternatively comprise a state machine made of discrete logic and other components.

In some embodiments, the display driver integrated circuit 5000 may incorporate Random Access Memory (RAM), flash memory, Electrically Erasable Programmable Read-Only Memory (EEPROM) and/or Read-Only Memory (ROM) (not shown). In some embodiments, display driver integrated circuit 5000 may include a frame buffer.

It is understood by those familiar with the art that the system described herein may be implemented in a variety of hardware or firmware solutions. It is understood by any person skill in the art that the methods described herein may be executed by a processor on a computer encoded with instructions encoded on a non-transitory computer-readable storage medium.

The previous description of the embodiments is provided to enable any person skilled in the art to practice the disclosure. The various modifications to these embodiments will be readily apparent to those skilled in the art, and the generic principles defined herein may be applied to other embodiments without the use of inventive faculty. Thus, the present disclosure is not intended to be limited to the embodiments shown herein, but is to be accorded the widest scope consistent with the principles and novel features disclosed herein.

What is claimed is:

1. An electronic apparatus comprising:
a display panel;
a display driver integrated circuit configured to receive an input signal frame comprising lines of pixels, calculate data voltage transition between the lines of pixels by a line subtractor resulting in a spatial interpolated voltage transition calculation, average a voltage across each column within the lines of pixels resulting in a group average voltage, calculate an aggressor value for a scan phase using the spatial interpolated voltage transition calculation and the group average voltage, compensate per the scan phase by correcting using the aggressor value and an input sub-pixel value by aligning with a corresponding first-in first-out (FIFO) buffer to result in compensation correction voltage values, sum the compensation correction voltage values with the input signal frame to result in a compensated output image frame; and,
the display panel further configured to display the compensated output image frame.

2. The electronic apparatus of claim 1, wherein the display panel is a light-emitting diode (LED) or liquid crystal display (LCD) display.

3. The electronic apparatus of claim 1, wherein the display panel is an organic light-emitting diode (OLED) display.

4. The electronic apparatus of claim 1, wherein the display panel is a computer.

5. The electronic apparatus of claim 1, wherein the display panel is a tablet computer.

6. The electronic apparatus of claim 1, wherein the display panel is a mobile phone.

7. The electronic apparatus of claim 1, wherein the display panel is a digital watch or augmented reality headset.

8. A method of operating an electronic apparatus comprising:
receiving an input signal frame comprising lines of pixels;
calculating data voltage transition between the lines of pixels by a line subtractor resulting in a spatial interpolated voltage transition calculation;
averaging a voltage across each column within the lines of pixels resulting in a group average voltage;
calculating an aggressor value for a scan phase using the spatial interpolated voltage transition calculation and the group average voltage;
compensating per the scan phase by correcting using the aggressor value and an input sub-pixel value by aligning with a corresponding first-in first-out (FIFO) buffer to result in compensation correction voltage values;
summing the compensation correction voltage values with the input signal frame to result in a compensated output image frame; and,
displaying the compensated output image frame on a display panel.

9. The method of claim 8, wherein the display panel is a light-emitting diode (LED) or liquid crystal display (LCD) display.

10. The method of claim 8, wherein the display panel is an organic light-emitting diode (OLED) display.

11. The method of claim 8, wherein the display panel is a computer.

12. The method of claim 8, wherein the display panel is a tablet computer.

13. The method of claim 8, wherein the display panel is a mobile phone.

14. The method of claim 8, wherein the display panel is a digital watch or augmented reality headset.

15. A non-transitory computer readable medium encoded with data and instructions, when executed by electronic apparatus the instructions causing the electronic apparatus to:
receive an input signal frame comprising lines of pixels;
calculate data voltage transition between the lines of pixels by a line subtractor resulting in a spatial interpolated voltage transition calculation;
average a voltage across each column within the lines of pixels resulting in a group average voltage;
calculate an aggressor value for a scan phase using the spatial interpolated voltage transition calculation and the group average voltage;
compensate per the scan phase by correcting using the aggressor value and an input sub-pixel value by aligning with a corresponding first-in first-out (FIFO) buffer to result in compensation correction voltage values;
sum the compensation correction voltage values with the input signal frame to result in a compensated output image frame; and,
display the compensated output image frame on a display panel.

16. The method of claim 15, wherein the display panel is a light-emitting diode (LED) or liquid crystal display (LCD) display.

17. The method of claim 15, wherein the display panel is an organic light-emitting diode (OLED) display.

18. The method of claim 15, wherein the display panel is a computer or tablet computer.

19. The method of claim 15, wherein the display panel is a mobile phone.

20. The method of claim 15, wherein the display panel is a digital watch or augmented reality headset.
